(19) United States
(12) Patent Application Publication
(10) Pub. No.: US 2007/0109684 A1
(43) Pub. Date: May 17, 2007

(54) THIN FILM MAGNETIC HEAD FOR PERPENDICULAR RECORDING

(75) Inventor: Kiyoshi Kobayashi, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/558,334

(22) Filed: Nov. 9, 2006

(30) Foreign Application Priority Data
Nov. 17, 2005 (JP) 2005-332869

(51) Int. Cl. G11B 5/147

(52) U.S. Cl. 360/126

(57) ABSTRACT

A thin film magnetic head is provided. The thin film magnetic head includes a first magnetic portion separated from a second magnetic portion in a perpendicular direction. A coil layer is disposed between the first magnetic portion and the second magnetic portion. A slot height determining layer is disposed on a gap layer of the first magnetic portion at a position spaced at a predetermined distance from the opposing surface in a height direction so as to extend in a track width direction. A coil layer is formed at an upper surface of the gap layer in a height direction of the slot height determining layer. A coil insulating layer is formed to cover the slot height determining layer and the coil layer while exposing one end thereof in a height direction of the first magnetic portion.

This application claims the benefit of Japanese Patent Application No. 2005-332869 filed Nov. 17, 2005, which is hereby incorporated by reference.

### BACKGROUND

1. Field

The present embodiments relate to a thin film magnetic head for perpendicular recording.

2. Related Art

There is known a thin film magnetic head that magnetizes a hard film of a recording medium in a perpendicular direction by applying a perpendicular magnetic field to the recording medium, which is called a perpendicular recording magnetic head (see JP-A-2001-43511 and JP-A-2005-122831 (US2005083608A1)). FIG. 5 shows a schematic cross-sectional view of a known perpendicular recording magnetic head.

In a thin film magnetic head 110, a slider 111 is formed of a non-magnetic material, such as Al₂O₃ TiC. A surface 111a of the slider 111 faces the recording medium M. When the recording medium M rotates, the slider 111 floats from a surface of the recording medium M by airflow along the surface and the slider 111 is kept at a predetermined gap from the recording medium M.

In FIG. 5, a traveling direction of the recording medium M with respect to the slider 111 is an A direction. As shown in FIG. 5, a direction perpendicular to the paper represents an X axis, a direction perpendicular to the A direction and parallel to the paper represents a Y axis, and a direction parallel to the A direction but opposite thereto represents a Z axis. In addition, the Y axis direction is a height direction.

On a trailing end surface of the slider 111, for example, an end surface in a direction opposite to the A direction in the drawing, a first coil layer 118 having a plurality of conductive members formed of a conductive non-magnetic material is formed through a coil insulating base layer 117. A coil insulating layer 119 formed of an inorganic insulating material, such as Al₂O₃, is formed around the first coil layer 118.

An upper surface 119a of the coil insulating layer 119 is planarized, and a main magnetic pole 120, a width of which in a track width direction at an opposing surface 110a is set to a track width, is formed on the upper surface 119a. The main magnetic pole 120 is formed through plating of a ferromagnetic material that has a high saturated magnetic flux density, such as Ni—Fe, Co—Fe, or Ni—Fe—Co, for example.

An insulating material layer 122 is provided around the main magnetic pole 120. An upper surface 120c of the main magnetic pole 120 and an upper surface 122a of the insulating material layer 122 formed around the main magnetic pole 120 are flush with each other.

A gap layer 123 formed of a non-magnetic material, such as alumina or SiO₂, is provided on the main magnetic pole 120 and a yoke portion 121, and the insulating material layer 122.

A second coil layer 125 is formed on the gap layer 123 with a coil insulating base layer 124 interposed therebetween. Like the first coil layer 118, the second coil layer 125 may have a plurality of conductive members 125 formed of a conductive non-magnetic metal material.

The first coil layer 118 and the second coil layer 125 are electrically connected to each other such that end portions in the track width direction (X direction in the drawing) form a troidal coil. With the first coil layer 118 and the second coil layer 125, a troidal coil layer that is wound with the main magnetic pole 120 and yoke portion 121 as a core is formed.

A coil insulating layer 126 made of an organic insulating material, such as a resist is formed on the second coil layer 125 covering around the second coil layer 125. A return yoke layer 127 is formed continuously to cover the coil insulating layer 126. The gap layer 123 is made of a ferromagnetic material, such as Permalloy. A front end surface 127a of the return yoke layer 127 is exposed at the opposing surface 110a. In addition, on a side higher than the opposing surface 110a, the main magnetic pole 120 is connected to the return yoke layer 127 through a connection portion 127b of the return yoke layer 127. Accordingly, a magnetic path connecting the main magnetic pole 120 and the return yoke layer 127 is formed.

FIG. 6 is a plan view that shows the thin film magnetic head before the return yoke layer 127 is formed. A slot height determining layer 128 is formed of an inorganic or an organic material on the gap layer 123 at a position space at a predetermined distance from the opposing surface 110a to the recording medium. A slot height (gap depth) length of the magnetic head is defined by the distance from the opposing surface 110a to a front edge of the slot height determining layer 128. The slot height determining layer 128 is formed longer than the second coil layer 125 and the coil insulating layer 126 in the track width direction.

In the related art, the slot height determining layer 128 is formed along the opposing surface 110a and the second coil layer 125 is formed on the slot height determining layer 128. Then, the coil insulating layer (resist) 126 formed by an organic insulating layer formed to cover the slot height determining layer 128 and the second coil layer 125.

However, since the coil insulating layer 126 has a rectangular shape in plan view and is rectangular parallelepiped in appearance, when the coil insulating layer 126 is baked, the organic insulating layer is shrunk and a corner portion of the rectangular shape rises, such that angular protrusions 126a may be formed (see FIG. 7). For example, if the angular protrusions 126a are formed at both corners of the coil insulating layer 126 close to the opposing surface 110a, the angular protrusions 126a are transferred to the return yoke layer 127 formed on the coil insulating layer 126 and then protrusions 127c are formed at the upper surface of the return yoke layer 127 (see FIG. 8). If the protrusions 127c are formed at corners of the return yoke layer 127 around the opposing surface 110a, there is a problem in that a magnetic flux to be returned to the return yoke layer 127 from the main magnetic pole 120 is disturbed or becomes abnormal.

### SUMMARY

The present embodiments may obviate one or more limitations of the related art. For example, in one embodiment, a thin film magnetic head prevents occurrence of an abnormal shape, such as a protrusion of a coil insulating layer.

In one embodiment, a thin film magnetic head includes a first magnetic portion that has a main magnetic pole at an opposing surface to a recording medium. A second magnetic portion is formed to be apart from the first magnetic portion in a perpendicular direction. A coil layer is formed between the first magnetic portion and the second magnetic portion.

A slot height determining layer is formed on a gap layer of the first magnetic portion at a position spaced at a predetermined distance from the opposing surface in a height direction so as to extend in a track width direction. The coil layer is formed at an upper surface of the gap layer in a height direction from the slot height determining layer.

In one embodiment, a coil insulating layer is formed to cover the slot height determining layer and the coil layer while exposing one end of the first magnetic portion in the height direction. The second magnetic portion is formed to cover the coil insulating layer and the exposed first magnetic portion. In the coil insulating layer, an inclination portion is formed to be inclined in the height direction in which a distance from the opposing surface becomes longer in the vicinities of both sides of the first magnetic portion along the opposing surface.

In one embodiment, a length of the slot height determining layer along the opposing surface may be longer than a length of the track width direction of the main magnetic pole and shorter than a length of the track width direction of the second magnetic portion. A portion of the coil insulating layer on the slot height determining layer may have an opposing portion that extends along the slot height determining layer and inclination portion that are inclined from both end portions of the slot height determining layer.

In one embodiment, an inclination portion and a side portion of the coil insulating layer along an edge that extends in the height direction of the first magnetic portion may have an obtuse angle.

In one embodiment, an inclination portion and a side portion of the coil insulating layer along an edge extending in the height direction of the first magnetic portion may form a curved portion. In the coil insulating layer, the inclination portion may have an outwardly convex shape.

In one embodiment, the first magnetic portion that has a main magnetic pole at a track width at an opposing surface to a recording medium, and the second magnetic portion that is formed to be wider than the track width are formed to be spaced from each other in a perpendicular direction. A second coil layer is interposed between the first magnetic portion of the first coil layer and the second magnetic portion. The first magnetic portion and the second magnetic portion are electrically connected to each other. A solenoid coil layer is formed to be wound around the first magnetic portion in a solenoid shape. The coil layer serves as the second coil layer.

In one embodiment, since the opposing surface of the coil insulating layer is the inclination portion inclined in the height direction, the side portion extending in the height direction is connected to the inclination portion at the obtuse angle and the angular protrusions do not occur at the corners of the coil insulating layer even though the coil insulating layer is subject to baking. Accordingly, the protrusions do not occur in the second magnetic portion to which the surface shape of the coil insulating layer is transferred and disorder of the magnetic flux does not occur.

In one embodiment, the slot height determining layer is longer than the length of the track width of the main magnetic pole and shorter than a length of the track width of the second magnetic portion, such that the inclination portions are formed from both end portions of the slot height determining layer. Therefore, efficiency of the magnetic flux to be returned to the second magnetic portion from the main magnetic pole is increased.

According to one embodiment with a portion connecting the inclination portion and the side part as a curved portion, it is possible to prevent the angular protrusions from occurring.

### BRIEF DESCRIPTION OF THE DRAWINGS

FIG. 1 is a longitudinal cross-sectional view that illustrates a thin film magnetic head of an embodiment;

FIG. 2 is a plan view that illustrates the thin film magnetic head in which a coil insulating layer is formed but a return yoke layer is not formed;

FIG. 3 is a view that illustrates the thin film magnetic head by an electron microscope before the return yoke layer is formed;

FIG. 4 is a plan view that illustrates the thin film magnetic head in which the return yoke layer is formed;

FIG. 5 is a longitudinal cross-sectional view that illustrates a thin film magnetic head according to the related art;

FIG. 6 is a plan view that illustrates the thin film magnetic head in which a coil insulating layer is formed but a return yoke layer is not formed according to the related art;

FIG. 7 is a view that illustrates the thin film magnetic head by an electron microscope in a state where a coil insulating layer is formed but a return yoke layer is not formed according to the related art; and

FIG. 8 is a plan view that illustrates the thin film magnetic head in which the return yoke layer is formed according to the related art.

### DETAILED DESCRIPTION

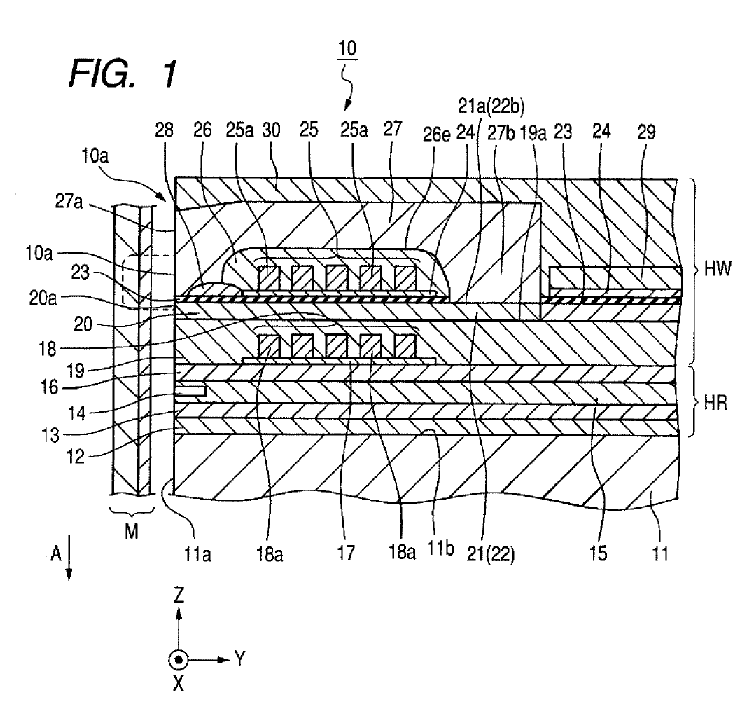

FIG. 1 is a longitudinal cross-sectional view that illustrates a magnetic head of one embodiment. The magnetic head 10 is a perpendicular recording magnetic head that magnetizes a hard film of a recording medium M in a perpendicular direction by applying a perpendicular magnetic field to the recording medium M using a writing head portion HW provided at an opposing surface 10a.

The perpendicular magnetic head 10 has a slider 11 that is formed of a non-magnetic material, for example Al₂O₃ TiC, and a surface 11a of the slider 11 opposes the recording medium M. When the recording medium M rotates, the slider 11 floats from the surface of the recording medium M and the slider 11 is kept apart at a predetermined gap from the recording medium M.

In FIG. 1, a traveling direction of the recording medium M with respect to the slider 11 is an A direction. As shown in FIG. 1, a direction perpendicular to the paper represents an X axis, a direction perpendicular to the A direction and parallel to the paper represents a Y axis, and a direction parallel to the A direction but opposite thereto represents a Z axis. The Y direction is a height direction.

As shown in FIG. 1, in the perpendicular magnetic head 10, individual members are formed in the Z axis direction (in a direction opposite to an arrow A) on a trailing end surface 11b of the slider 11. A non-magnetic insulating layer 12 formed of an inorganic material, for example, Al₂O₃ or SiO₂, is formed on the trailing end surface 11b of the slider 11. A reading head portion HR is formed on the non-magnetic insulating layer 12. The reading head portion HR includes a lower shield layer 13, an upper shield layer 16, and a reading element 14 disposed in an inorganic insulating layer (gap insulating layer) 15 interposed between the lower shield layer 13 and the upper shield layer 16. In addition, the reading element 14 is a magnetoresistive effect element, for example, AMR, GMR, or TMR. A writing head portion HW for perpendicular recording is formed on the upper shield layer 16 of the reading head portion HR.

On the upper shield layer 16, a first coil layer 18 that has a plurality of conductive members 18a formed of a conductive material is formed through a coil insulating base layer 17. The first coil layer 18 may have a single layer structure or a laminated structure of one conductive non-magnetic metal material or two or more conductive non-magnetic metal materials selected from a group of, for example, Au, Ag, Pt, Cu, Cr, Al, Ti, NiP, Mo, Pd, or Rh.

A coil insulating layer 19 formed of an inorganic insulating material, for example, Al₂O₃, or an organic insulating material, such as resist, is formed around the first coil layer 18. An upper surface 19a of the coil insulating layer 19 is planarized, and a main magnetic pole 20 is formed at the upper surface 19a, such that a width in a track width direction of an end surface 20a exposed at the opposing surface 10a becomes a track width. The main magnetic pole 20 is formed in a tapered shape in the height direction (at the rear side) from the opposing surface 10a. The main magnetic pole 20 is formed by plating of a ferromagnetic material that has a high saturated magnetic flux density, for example, Ni—Fe, Co—Fe, or Ni—Fe—Co. In one embodiment, on the main magnetic pole 20, a rectangular portion extending in the height direction from a wider portion of the tapered portion forms a yoke portion 21. The main magnetic pole 20 and the yoke portion 21 form a first magnetic portion.

On the upper surface 19a of the coil insulating layer 19, an insulating material layer 22 is provided around the main magnetic pole 20. An upper surface of the insulating material layer 22 formed around the main magnetic pole 20 are flush with an upper surface of the main magnetic pole 20. The insulating material layer 22 can be formed of one material or two or more materials selected from a group of, for example, alumina (Al₂O₃), SiO2, Al—Si—O, Ti, W, or Cr.

A gap layer 23 formed a non-magnetic material, for example, alumina, SiO₂, Au, or Ru, is provided on the main magnetic pole 20 and the yoke portion 21, and on the insulating material layer 22.

A second coil layer 25 is formed on the gap layer 23 with a coil insulating base layer 24 interposed therebetween. Like the first coil layer 18, the second coil layer 25 has a plurality of conductive members 25a formed of, for example, a conductive non-magnetic metal material. The second coil layer 25 is formed of one material or two or more materials selected from a group of, for example, Au, Ag, Pt, Cu, Cr, Al, Ti, NiP, Mo, Pd, or Rh. In one embodiment, the second coil layer 25 may have a laminated structure of the non-magnetic metal materials. The insulating layer includes the insulating material layer 22, the gap layer 23, and the coil insulating base layer 24.

Though not shown, the conductive portion 18a of the first coil layer 18 and the conductive portion 25a of the second coil layer 25 are electrically connected to each other such that respective end portions in the track width direction (X direction in the drawing) form a solenoid coil. The first coil layer 18 and the second coil layer 25 form a solenoid coil layer that is wound with the main magnetic pole 20 and the yoke portion 21 as a core. In this embodiment, the width of the first coil layer 18 in the height direction (Y direction in the drawing) is the same as the width of the second coil layer 25 in the height direction (Y direction in the drawing).

A coil insulating layer 26 formed of an organic insulating material, such as resist, is formed around the second coil layer 25. A return yoke layer 27 that forms a second magnetic portion is continuously formed to cover the coil insulating layer 26 and the gap layer 23 using a ferromagnetic material, such as Permalloy. The front end 27a of the return yoke layer 27 is exposed at the opposing surface 10a to the recording medium. In one embodiment, on a side higher than the opposing surface 10a, the main magnetic pole 20 is connected to the return yoke layer 27 through a connection portion 27b of the return yoke layer 27 exposed from the coli insulating layer 26. Accordingly, a magnetic path that connects the main magnetic pole 20 and the return path layer 27 is formed. In another embodiment, a thin film magnetic head may have the main magnetic pole 20 which is not connected to the return yoke layer 27, for example, having no connection portion 27b.

A slot height determining layer 28 is formed on the gap layer 23 by using an inorganic or an organic material at a position spaced at a predetermined distance from the opposing surface 10a. A slot height (gap depth) length of the perpendicular magnetic head 10 is defined by a distance from the opposing surface 10a to a front end of the slot height determining layer 28.

In the height direction (Y direction in the drawing) of the connection portion 27b of the return yoke layer 27, a lead layer 29 extending from the second coil layer 25 is formed on the coil insulating base layer 24. The return yoke layer 27 and the lead layer 29 are covered with a protective layer 30 formed of an inorganic non-magnetic insulating material or the like.

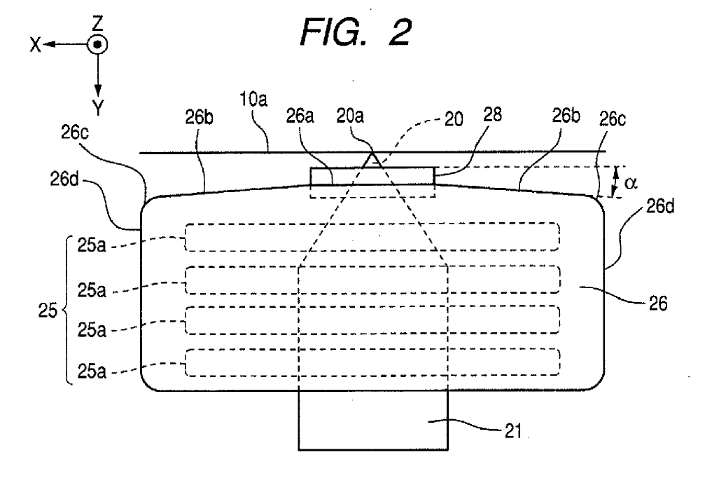

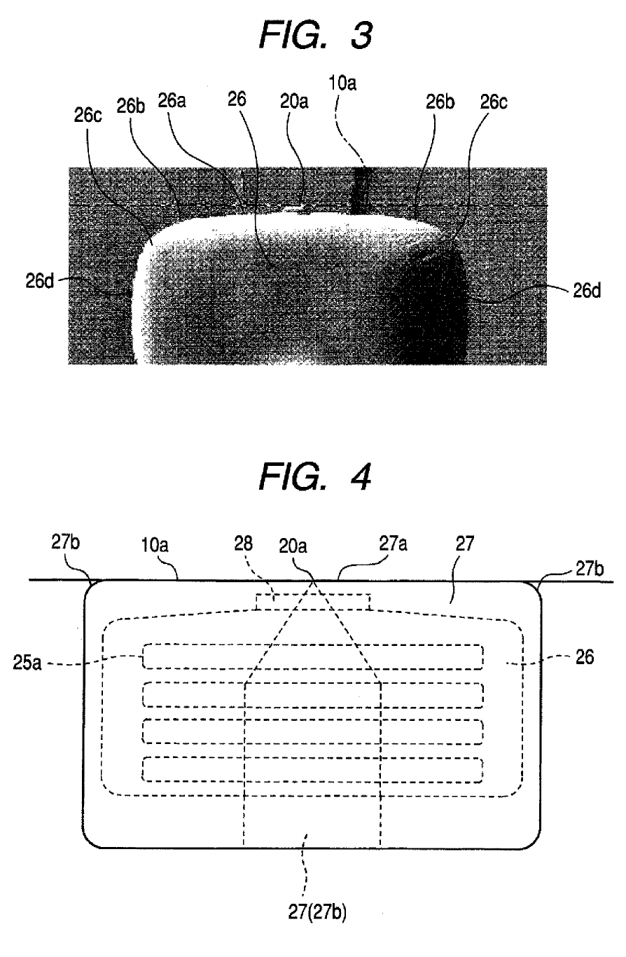

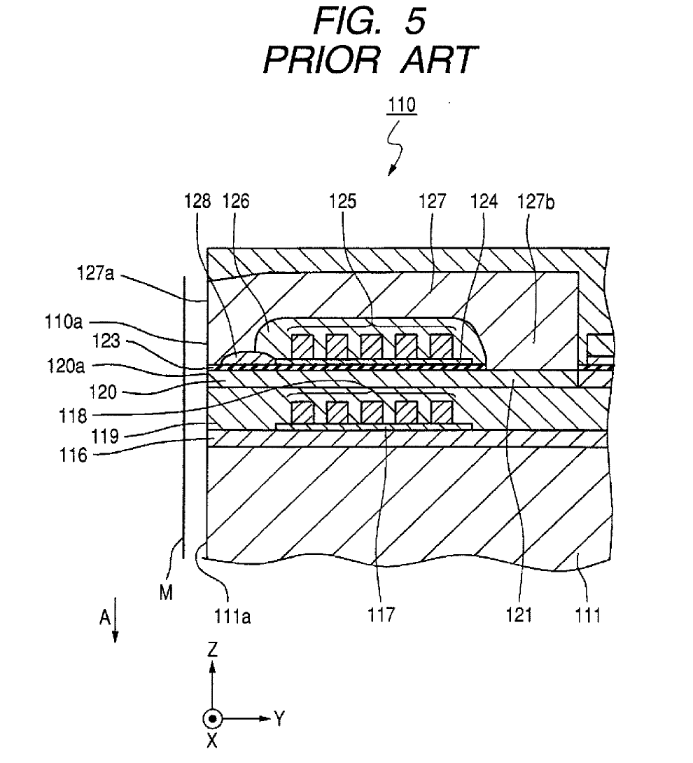

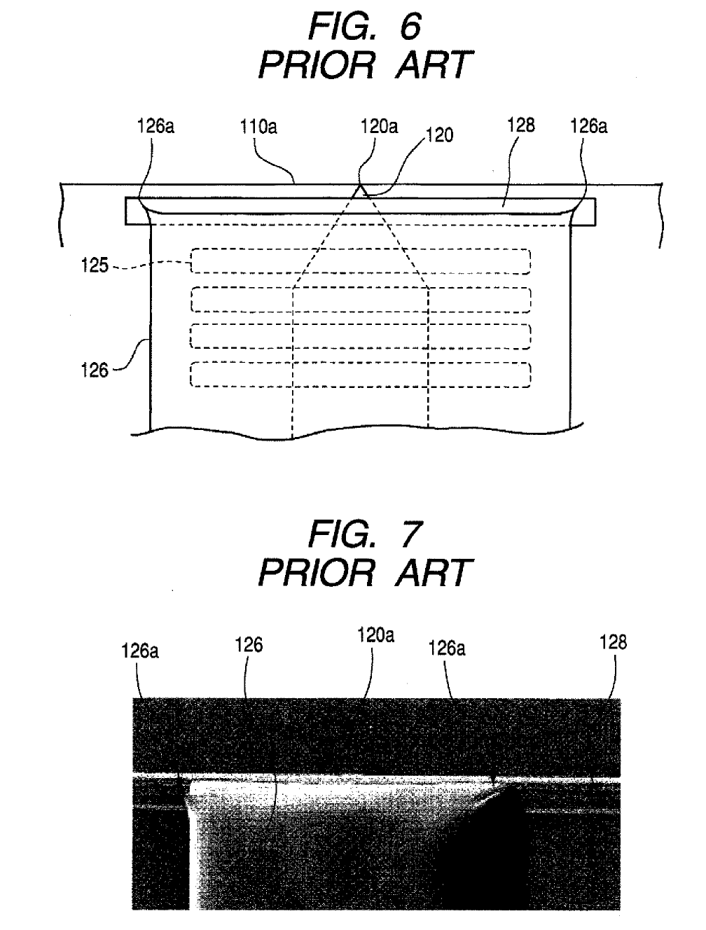

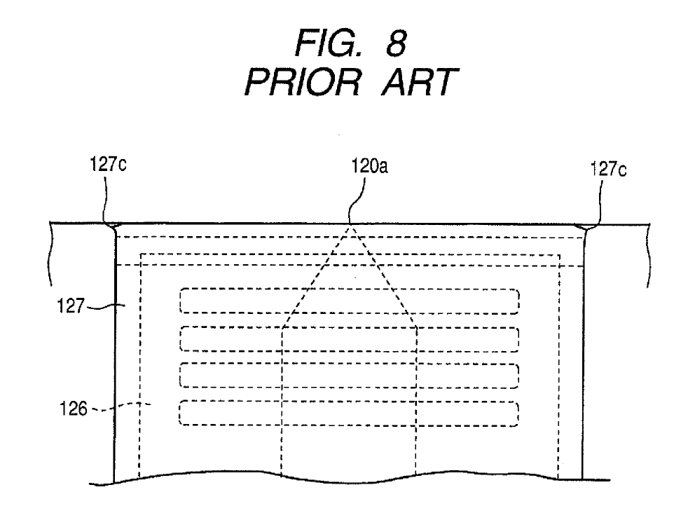

FIG. 2 is a plan view that illustrates a thin film magnetic head in which a coil insulating layer 26 is formed but a return yoke layer 27 is not formed. FIG. 3 is a view by an electron microscope after the thin film magnetic head is subject to baking. FIG. 4 is a plan view that schematically illustrates the thin film magnetic head in which the return yoke layer 27 is formed.

The slot height determining layer 28 is formed along the opposing surface 10a so as to have substantially the same width as the yoke portion 21 of the main magnetic pole 20. For example, the height determining layer 28 is longer than the length of the track width direction of the main magnetic pole 20 and is shorter than the length of the track width direction of the return yoke layer 27 that forms a second magnetic portion. With this configuration, in the appearance of the coil insulating layer 26, a portion over the slot determining layer 28 becomes an opposing portion 26a that overlaps the slot determining layer 28 and, at both end portions of the opposing portion 26a around the slot determining layer 28, inclination portions 26b are formed to be inclined in the height direction away from the opposing surface 10a. In addition, in the coil insulating layer 26, a curved portion 26c extends from the inclination portion 26b and a side portion 26d is continuously connected to the curved portion 26c and extend in the height direction substantially perpendicular to the opposing surface 10a.

Baking is performed for the perpendicular magnetic head 10 on which the coil insulating layer 26 is formed so as to dry a solvent of the organic insulating layer (see FIG. 3). In the coil insulating layer 26, the inclination portion 26b and the side portion 26d have an obtuse angle to be connected through the curved portion 26c. Accordingly, when the coil insulating layer 26 is subject to baking, even though the coil insulating layer 26 is shrunk, the curved portion 26c is bent backward such that neither angular protrusion is formed nor the coil insulating layer 26 is transformed. For example, a surface and the appearance of the coil insulating layer 26 are smoothly formed. In one embodiment, boundary portions of the facing portion 26a, the inclination portion 26b, the curved portion 26c, and the side portion 26d are wound.

Subsequently, the return yoke layer 27 is formed around the coil insulating layer 26 on the gap layer 23, the slot height determining layer 28, the coil insulating layer 26, the mail magnetic pole 20, and the yoke portion 21. In one embodiment, surface shapes of the gap layer 23, the slot height determining layer 28, and the coil insulating layer 26 of the base layer are transferred to the return yoke layer 27. Since the surface shape of the coil insulating layer 26 is smooth (see FIG. 3), the shape of the return yoke layer 27 to which the surface shape of the coil insulating layer 26 is transferred becomes smooth. Therefore, there is no thorn or protrusion.

In one embodiment, a corner portion of the return yoke layer 27 to which the shape of the curved portion 26c of the coil insulating layer 26 is transferred is a curved surface portion 27c and there is no protrusion. Therefore, the curved surface portion 27c of the return yoke layer 27 rarely affects the magnetic flux to be returned to the return yoke layer 27 from the main magnetic pole 20. The slot height determining layer 28 is formed to be narrower than the width of the yoke portion 21 of the main magnetic pole 20. Therefore, the magnetic flux to be returned to the return yoke layer 27 from the main magnetic pole 20 converges on the return yoke layer 27 around the opposing portion 27a, thereby improving efficiency.

In another embodiment, the yoke portion 21 of the main magnetic pole 20 is exposed from the end portion of the coil insulating layer 26 in the height direction. Therefore, the side surface in the height direction where the coil insulating layer 26 comes into contact with the yoke portion 21 is smooth. Accordingly, upon plating of the return yoke layer 27, it is not necessary to etch the yoke portion 21.

In one embodiment, an angle between the inclination portion 26b and the Y axis direction is not less than about 5 degrees and less than about 30 degrees. For example, even though the angle between the side portion 26d and the inclination portion 26b is an obtuse angle less than 90 degrees, a preferable angle is approximately 110 degrees. In addition, the same effect can be obtained when the inclination portion 26b, the curved portion 26c, and the side portion 26d are formed in an outwardly convex shape, for example, when the inclination portion 26b, the curved portion 26c, and the side portion 26d are formed in an outwardly curved line in a convex shape in plan view. In one embodiment, the curved surface portion 26c has a three-dimensionally smooth convex shape.

In one embodiment, a spiral perpendicular magnetic head can be used instead of a solenoid coil type perpendicular magnetic head.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A thin film magnetic head comprising:
a first magnetic portion that has a main magnetic pole at an opposing surface to a recording medium;
a second magnetic portion that is disposed away from the first magnetic portion in a perpendicular direction; and
a coil layer that is disposed between the first magnetic portion and the second magnetic portion,
wherein a slot height determining layer is formed on a gap layer of the first magnetic portion at a position spaced at a predetermined distance from the opposing surface in a height direction so as to extend in a track width direction,
a coil layer is formed at an upper surface of the gap layer in a height direction of the slot height determining layer,
a coil insulating layer is formed to cover the slot height determining layer and the coil layer while exposing one end thereof in a height direction of the first magnetic portion,
the second magnetic portion is formed to cover the coil insulating layer and the exposed first magnetic portion, and
in the coil insulating layer, an inclination portion is formed to be inclined in the height direction in which a distance from the opposing surface becomes longer in the vicinities of both sides of the first magnetic portion along the opposing surface.

2. The thin film magnetic head according to claim 1,
wherein a length of the slot height determining layer along the opposing surface is longer than a length of the track width direction of the main magnetic pole and shorter than a length of the track width direction of the second magnetic portion, and
a portion of the coil insulating layer on the slot height determining layer has an opposing portion that extends along the slot height determining layer and inclination portions that are inclined from both end portions of the slot height determining layer.

3. The thin film magnetic head according to claim 1,
wherein an inclination portion and a side portion of the coil insulating layer along an edge that extends in the height direction of the first magnetic portion has an obtuse angle.

4. The thin film magnetic head according to claim 1,
wherein an inclination portion and a side portion of the coil insulating layer along an edge extending in the height direction of the first magnetic portion form a curved portion.

5. The thin film magnetic head according to claim 1,
wherein, in the coil insulating layer, the inclination portion has an outwardly convex shape.

6. The thin film magnetic head according to claim 1,
wherein the first magnetic portion that has a main magnetic pole at a track width at an opposing surface to a recording medium, and the second magnetic portion that is formed to be wider than the track width are spaced apart from each other in a perpendicular direction,
a second coil layer is interposed between the first magnetic portion of the first coil layer and the second magnetic portion,
the first magnetic portion and the second magnetic portion are electrically connected to each other,
a solenoid coil layer is formed to be wound around the first magnetic portion in a solenoid shape, and
the coil layer serves as the second coil layer.
